(19) United States
(12) Patent Application Publication
(10) Pub. No.: US 2008/0102766 A1
(43) Pub. Date: May 1, 2008

(54) System and method for user identity authentication via mobile communication devices

(76) Inventor: Michael J. Schultz, San Jose, CA (US)

Correspondence Address: PERKINS COIE LLP, P.O. BOX 2168, MENLO PARK, CA, 94026, US

(21) Appl. No.: 11/789,495

(22) Filed: Apr. 24, 2007

Related U.S. Application Data
(60) Provisional application No. 60/863,746, filed on Oct. 31, 2006.

(51) Int. Cl. H04M 1/727

(52) U.S. Cl. 455/110; 455/551

(57) ABSTRACT

Various embodiments of the present invention enable user identity authentication, which accepts and validates information of a user applying and/or possessing a mobile communication service, establishes an identity of the user, and associates the identity of the user with a mobile communication number of the user or a third party.

### RELATED APPLICATIONS

This application claims priority to U.S. Provisional Patent Application No. 60/863,746, filed Oct. 31, 2006, and entitled “Integrated Mobile Communication System Using User-Guided Search Function and Providing Interactive Communication Over Disparate Communications Platforms,” by Michael J. Schultz, and is hereby incorporated herein by reference.

### BACKGROUND

1. Field of Invention

This invention relates to the field of user identity authentication and verification.

2. Background of the Invention

Since the advent of widespread use of the internet in early 1990's, the internet has served as a platform for a variety of e-socializing venues. On-line games and gaming communities, bulletin boards, chat rooms, message boards, weblogs, and interactive online communities such as Myspace, Flickr, eHarmony provide numerous opportunities for children and adults to meet, socialize, recreate, and in some cases date. Such popularity of web-based communities and socializing networks demands a safe and secure electronic environment for people, especially children, to socialize, recreate, and be educated. Parents should also have the option to authorize their children's activities online and be notified if there is anything suspicious going on.

In recent years, crimes related to identity theft have become an increasingly serious threat not only to those people with lost or stolen credit cards, but also to the public in general as highly sensitive personal information stored at financial institutions and government agencies are more and more frequently hacked or lost. Therefore, there is a strong need for an identity verification system, which allows a person to conveniently and promptly authorize any major activities being initiated under his/her name.

Mobile communication devices, which include but are not limited to, cell phones, PDAs, Blackberries, and Sidekick systems, are being used ubiquitously. As users often carry these mobile communication devices with them at all times, these devices offer unique opportunities to validate users' identities in real time when an attempted is being made to enter a secure website, transact with credit cards, or initiate credit checks.

### SUMMARY OF INVENTION

Various embodiments of the present invention enable user identity authentication, which accepts and validates information of a user applying and/or possessing a mobile communication service, establishes an identity of the user, and associates the identity of the user with a mobile communication number of the user or a third party.

### BRIEF DESCRIPTION OF THE DRAWINGS

The features and objects of the present invention is illustrated by way of example in the accompanying drawings. The drawings should be understood as illustrative rather than limiting.

FIG. 1 shows an exemplary system for user identity authentication in accordance with various embodiments of the present invention.

FIG. 2 shows an exemplary system for user identity verification in accordance with various embodiments of the present invention.

### DETAILED DESCRIPTION OF EMBODIMENTS OF THE INVENTION

The specific embodiments described in this document represent examples or embodiments of the present invention, and are illustrative in nature rather than restrictive. In the following description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the invention. Features and aspects of various embodiments may be integrated into other embodiments, and embodiments illustrated in this document may be implemented without all of the features or aspects illustrated or described.

Various embodiments of the present invention enable two separate phases of user identity verification: user identity authentication phase, which authenticates a user's identity and associates it with a mobile communication number; user identity validation phase, which allows the authenticated user to authorize, via a mobile communication device associated with the mobile communication number, an activity being initiated at a service provider.

As used in the present disclosure, the term “validation” or “verification” shall be defined as confirmation of an identity of a user.

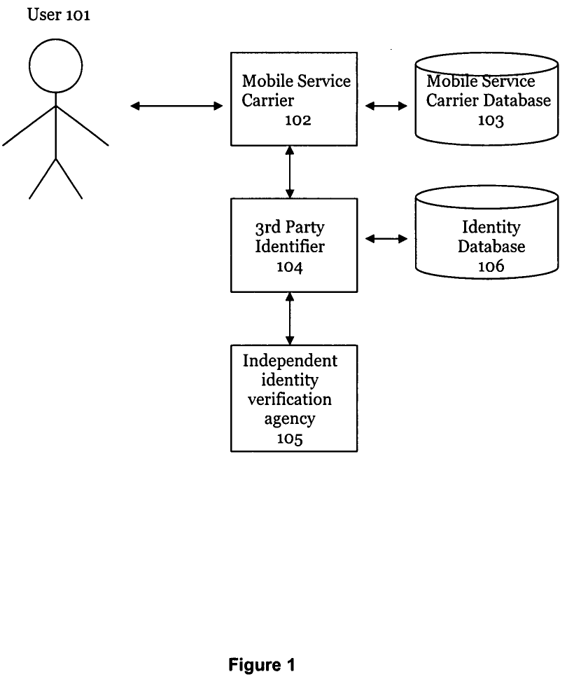

FIG. 1 shows an exemplary system for user identity authentication in accordance with various embodiments of the present invention. The user identity authentication phase begins when a prospective user 101 applies for or registering a mobile service with a mobile communication service carrier 102, wherein the mobile communication service can be but is not limited to, cell phone service, page service, short messaging service, and Blackberry service. During the application process, the user is required to provide to the mobile communication service carrier one or more of the following: social security number, driver license number, birth date, one or more credit card numbers, address, one or more telephone numbers, one or more e-mail addresses, and first and last name of the user. The mobile service carrier then validates the user information by cross-referencing with the mobile service carrier's database 103. Once the user's information is authenticated, the mobile service carrier assigns a mobile communication number to the user, wherein the mobile communication number can be but is not limited to, a cell phone number, a page number, an instant messaging number, or any other mobile communication id.

In some embodiments, the user or third party must provide key information to associate his/her mobile communication device with the mobile communication number. For a non-limiting example, the user may provide a mobile communication identifier, a SIM card identifier and another data point, such as a social security number (SSN), to verify his/her identity with the mobile service carrier. Artisans will recognize and appreciate any number combinations may be used for this purpose, provided a baseline level of security is maintained.

For further authentication, a (third party) identifier 104 can validate the user's identity by cross-referencing it with an independent identity verification agency 105, which can be but is not limited to, a national ID registry and/or a credit reporting agency. Once the user's identity is further authenticated, the identifier can then proceed to establish an identity for the user, and associate such identity with the mobile communication number.

In some embodiments, the identifier may store the identity of the user, the information of the user, and the mobile communication number associated with the user in one record in an identity database 106. Due to its sensitive nature, such record should be highly secured and optionally encrypted. Such record can be indexed and be made searchable via any of the information of the user, such as credit card number, social security number, name, or mobile communication number upon request.

In some embodiments, if the user is a minor or someone whose activities require prior authoritative approval, the information of a third party must also be authenticated and its identity be established. Here, the third party can be the parent(s), guardian of the minor, or an authoritative figure or agency. Instead of associating the user's mobile communication number with the user's identity, however, the identifier will associate the third party's mobile communication number with the user's identity and information instead, together with the third party's identity and information.

After the user's identity is authenticated, he/she may sign up for a service provided by a service provider, where the user desires additional security and wishes to have his/her identity confirmed (validated) prior to certain activities are granted by the service provider. For a non-limiting example, the user may sign up for a bank account, wherein he/she wishes bank to verify his identity prior to online login and access to his/her bank account. Accordingly, the bank would then verify the identity of the user before allowing the user to proceed with his desired activity. For another non-limiting example, the user may initiate access to an e-mail account or an e-socialization forum such as MySpace via either a mobile communication device or a computing device such as desktop or laptop computer. The service provider may then send a confirm request to validate the user's identity before granting the user access to the account/forum. Artisans will appreciate these specific embodiments are merely exemplary and demonstrate the principles that may be broadly applied and implemented depending on the service and associated systems.

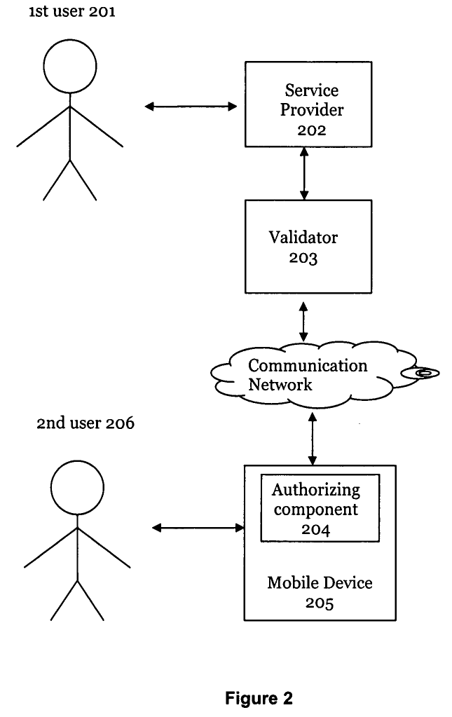

FIG. 2 shows an exemplary system for user identity verification in accordance with various embodiments of the present invention. The user identity verification phase is triggered when a first user 201 initiates an activity via an interface to a service provider 202. Here, the service provider can be but is not limited to a financial institution or a Web service provider. The activity initiated can be but is not limited to a financial transaction or an access request to a website. More specifically, the financial transaction can be a credit card transaction that is over a preset limit and/or outside of a certain geographic area. The website can be a highly secured online community that can be accessed by authorized person only, such as a website for under-aged children only.

In some embodiments, the service provider may not grant the activity being initiated immediately due to the high sensitive nature of such activity. Instead, it may choose to communicate a request to a validator 203 to confirm the user's true identity, wherein the request may include among other things a brief description of the user's activity and the information of the user as described above. In the meantime, the service provider may block the activity initiated by the user temporarily until the user's the identity is verified. Here, the validator can be associated with the service provider or be an independent third party.

In some embodiments, the service provider may grant or deny the user's activity according a response to grant or deny received from the validator, which in turn receives the response from a second user as discussed later. Alternatively, the service provider may request the first user to enter an authorization code to proceed, wherein such authorization code can be randomly generated and provided by the service provider to the second user.

In some embodiments, the user's activity will be denied if a response to grant or deny the activity is not received by the service provider within a certain period of time. Alternatively, the randomly generated authorization code may be valid for only a certain period of time, for a non-limiting example, two minutes. Thereafter, a new randomly generated authorization code will need to be generated for the first user to conduct the desired activity. Consequently, if the authorization code is not entered within the certain period of time, the first user's activity may be denied, thus creating a limited or expireable “key” to the activity.

In some embodiments, the service provider can communicate with the validator via a virtual private network (VPN), which can be a high-speed dedicated network that permits the transfer of large amounts of data with nearly no transmission lag time. Through the use of a private and dedicated network, communications of all forms are received by recipient in a quasi-instantaneous form with little perceptible delay. This enables nearly instantaneous communication between the service provider and the validator even on disparate platforms and mobile operating systems, to communicate via one or more of: text, voice, images, and games.

Once the validator receives the request for confirmation from the service provider to confirm the identity of the first user, it will first identify the mobile communication number associated with the identity of the first user that has been authenticated as discussed above. Such identification process can be done by searching the identity database containing records associating the first user's identity and his/her information with the mobile communication number, using one or more of the user information described above.

After the validator identifies the mobile communication number associated with the true identity of the first user, it will proceed to send a request for authorization of the activity initiated by the first user to a second user 206 at the mobile communication number identified. Such request can be accepted by an authorizing component 204 running at a mobile communication device 205 associated with the mobile communication number (and the second user). The authorizing component can be a downloaded software component running on a mobile communication device associated with the mobile communication number. The request for authorization may contain one or more of: the nature of the activity to be authorize, information of the first user who initiated the activity, and from where such activity is initiated. Alternatively, the validator may forward the authorization code it received from the service provide to the second user. The second user may inspect the nature of the activity, by whom and/or from where it is initiated, before deciding whether to authorize or deny the activity. Once a response to authorize or deny the activity sent from the second user at the mobile communication number is received by the validator, the validator communicates the response back to the service provider. In case the authorization code is forwarded to the second user, he/she is required to enter it on the mobile communication device associated with the mobile communication number to authorize the activity. If the second user does not respond or enter the authorization code within a certain period of time, in the exemplary situation where the second user is away from the mobile communication device, the device is turned off, out of service area or simply lost, the validator will communicate a response denying the activity back to the service provider.

In some embodiments, the first and the second user are the same person. This happens under the exemplary scenario that a person is initiating an important financial transaction, and the service provider would require the person to confirm via the mobile communication device associated the mobile communication number that it is him/her, not an unauthorized party who has stolen the credit card for a non-limiting example, is actually initiating the transaction. Such authorization would be especially desirable if the amount of the transaction is over a certain preset limit or the location of the transaction is outside of certain geographic area.

In some embodiments, the first and the second user are different persons. This happens under the exemplary scenario that the first user is an under-aged child or anyone who needs permission from another person to conduct certain activities. The service provider would require the second user—the parent or guardian of the child or the party who has the authority to grant certain activities initiated by the first user, to authorize the first user to conduct such activities, such as purchase of goods and access to a secured online community.

In some embodiments, the validator can communicate with the authorizing component at the mobile communication number via an e-mail, an instant messaging (IM), short messaging system (SMS), a multimedia messaging system (MMS), Wireless Application Protocol (WAP), or any other method suitable for the user to interface with the mobile communication number. Such communication is carrier independent and it enables affordable and nearly instantaneous communication between the validator and the second user at the mobile communication number even on disparate platforms and mobile operating systems to communicate via one or more of: text, voice, and images. The validator and/or the second user may specify the communications protocol to be used, provided the second user's mobile communication device supports it. In addition, the mobile communication device may be equipped with specialized circuitry or software to facilitate seamless integration with validation.

In essence, the entire user identity verification process provides a “keyhole” for the purpose of identity validation of the first user, while the second user's mobile communications device may be used generally as a validation tool or “key” for validating the first user's identity and authorizing the first user to conduct the activity to access secured environments online and offline. It will be understood by artisans, according to embodiments, that the principles of the present disclosure are applicable generally to any application where security and confirmation of identity is desirable.

In some embodiments, the process described above may be used for user identity validation in high security applications, such as use of credit cards, for a non-limiting example. A credit card user may initially have his/her information and identity authenticated and associated with a mobile communication number following the identity authentication process described above. The credit card company issuing the credit card may then be instructed to seek verification from the user at his/her mobile communications number prior to one or more of: all credit card transactions, transactions that exceed predetermined amount of money, when total transactions over a given time period exceed a predetermined amount of money, or based on geography (e.g., the credit card is used in a different state). The user's mobile communication number would then be sent a validation request that would need to be responded to.

In some embodiments, a random secondary authorization code, or similar methods of validating the transaction that would be known or readily apparent to a person of ordinary skill in the art, would need to be entered in conjunction with the transaction. The user may select a menu item on the mobile communications device, or signal through a WAP browser to reply to an SMS, MMS, EMS, email. No transaction on the credit card would be permitted until validation occurs. In the event that the user declines to validate the credit card purchase, the user would have to either call the credit card company or enter a pin number on the mobile communications device prior to allowing approval of further transactions using the card. When validation is required only for large purchases, the card may be used for smaller purchases without restriction even if a user declines to validate with their mobile communications device. A person of ordinary skill in the art will appreciate the variations on the consequences of failing to validate purchases and related measures for added security. These principles could apply to credit card purchases, debit card purchases, bank withdrawals, use of traveler's checks, and other activities where confirmation of identity in person is important.

In some embodiments, the credit card company may require user validation if over $500 of purchases are attempted over a four hour period. This limits the thieves' window of opportunity for use of stolen credit cards prior to card deactivation. In circumstances where a larger time period elapses prior to the credit card owner discovering the loss of the credit card, validation serves the dual purpose of both alerting the user of a missing card as well as preventing financial losses to the user or to the credit card company. Similar principles apply geographically—validation may be required for use of the credit card in geographical areas in which the card is not normally used.

In some embodiments, credit agencies may use the process of the present disclosure to discourage or prevent identity theft. By associating a person's Social Security Number (SSN) to a mobile communication number, the credit agencies may require validation of the use of the SSN for securing a line of credit prior to providing a credit score to inquiring institutions. For a non-limiting example, a user applying for a bank loan must submit personal information to the bank so the bank could conduct a credit check. After the bank inquires with the credit reporting agencies or a third party validator, the user will be notified that a credit check is being conducted and will be required to validate the credit check, as disclosed herein. The credit company will not issue a credit score until validation is provided. Once the user validates his/her identity via his/her mobile communication number or by other secure communications devices that have been associated to his/her identity, the credit score may be provided. In instances where validation is not completed within an allotted time span or is refused, the credit score may be withheld or may be provided with warnings to the bank that validation could not be obtained. Thus, the bank would be alerted to a potential identity thief and may refuse the loan, as well as notify authorities. In aggregate, the processes disclosed herein improve the security for users for transactions that may result in financial losses to the user. These processes are relatively unobtrusive and occur in a relatively short period of time and in person to avoid unnecessary delays that might otherwise be incurred if validation occurs by telephone call, mail, internet, and other traditional validation methods.

In all the examples discussed above, the person who authorizes the financial transaction may be different from the one who has initiated it. For non-limiting examples, the person who authorizes or denies the transaction may be parent, spouse, partner, guardian, or any authoritative figure of the person who initiated the transaction. More specifically, parents who gave emergency credit cards to minors may exercise control over the purchases and spending habits of minors using these credit cards.

In some embodiments, users of a Web-based service, such as an e-socialization community, may interact with others in a safe and secure ecosystem that excludes non-members and also proactively protects users from undesirable or uninvited communications. Exclusion of non-members is accomplished via member identity authentication using a user database populated with information provided at the time of user subscription in combination with real time user identity validation by the user. Use of a mobile communication device, such as a mobile phone or a mobile messaging device as a validation tool therefore provides a mechanism for validating users accessing sensitive or private information where security is of importance; the system may also be used to limit other users from access to inappropriate content as well. For a non-limiting example, parents may exercise a greater degree of control on sites that contain content that may not be deemed appropriate for children by blocking children's access to the sites remotely via mobile communication devices.

In some embodiments, the third party authoritative figure required to authorize a user's activity can be but is not limited to, local, national, and international police entities or any institution requesting validation to secure a safe online socializing environment. The present disclosure contemplates coordinating the lightweight direct access protocol and the online analytical processing databases with national and international police entities to track down and prosecute dangerous child predators. Moreover, because access to the system disclosed herein is predicated on the novel authentication system using a combination of user code, mobile carrier account information, national identification numbers, and device identifications, according to embodiments, predators will find that the use of aliases and rotating accounts nearly impossible to accomplish. Thus, a predator caught will have a difficult time regaining access to the system without first obtaining a new national identification number, mobile communication number, and a mobile communication device account. As these identification points may be tracked by local, national, and international authorities once the identity of the predator is known, the administrators of the service may monitor and working together with national and international police entities to update a black list of users who are not permitted access to the system.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, bean, module, object model, and other suitable concepts. While the concept “interface” is used in the embodiments of the systems and methods described above, it will be evident that such concept can be interchangeably used with equivalent concepts such as, class, method, type, component, bean, module, object model, and other suitable concepts. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A system to support user identity authentication, comprising:
a verifier operable to authenticate a user's identity based on information of the user;
an identifier operable to associate the user's identity with a mobile communication number.

2. The system of claim 1, wherein:
the information of the user includes one or more of: social security number, driver license number, birth date, one or more credit card numbers, address, one or more telephone numbers, one or more e-mail addresses, and first and last name of the user.

3. The system of claim 1, wherein:
the mobile communication number is one of a cell phone number, a page number, an instant messaging number, or any other mobile communication id.

4. The system of claim 1, further comprising:
a database operable to store the identity of the user, the information of the user, and the mobile communication number associated with the user in a record.

5. The system of claim 4, wherein:
the identifier is further operable to identify the mobile communication number associated with the identity of the user by searching the database containing the record associating the user's identity and information with the mobile communication number.

6. A method to support user identity authentication, comprising:
authenticating a user's identity based on a plurality of information of the user; and
associating the user's identity with a mobile communication number.

7. The method of claim 6, further comprising:
storing the identity of the user, the information of the user, and the mobile communication number associated with the user in a record.

8. The method of claim 7, further comprising:
identifying the mobile communication number associated with the identity of the user by searching the record associating the first user's identity and information with the mobile communication number.

9. A system to support user identity authentication, comprising:
an verifier operable to:
accept information of a user applying for a mobile communication service; and
authenticate the information of the user;
an identifier operable to:
establish an identity of the user; and
associate the identity of the user with a mobile communication number.

10. The system of claim 9, wherein:
the verifier is a mobile service provider or an independent identity verification agency.

11. The system of claim 9, wherein:
the mobile communication service is one of: cell phone service, page service, short messaging service, and Blackberry service.

12. The system of claim 9, wherein:
the verifier is further operable to assign a mobile communication number to the user if the information of the user is validated; and
the identifier is further operable to associate the identity of the user with the mobile communication number of the user.

13. The system of claim 9, wherein:
the verifier is further operable to:
accept information of a third party; and
validate the information of the third party; and
the identifier is further operable to:
establish an identity of the third party; and
associate the identity of the user with a mobile communication number of the third party.

14. The system of claim 13, wherein:
the third party can be a parent, guardian of the user, or an authoritative figure/agency who has the authority over the user's activities.

15. A method to support user identity authentication, comprising:
accepting information of a user applying and/or possessing a mobile communication service;
validating the information of the user;
establishing an identity of the user; and
associating the identity of the user with the mobile communication number.

16. The method of claim 15, further comprising:
assigning a mobile communication number to the user; and
associating the identity of the user with the mobile communication number of the user.

17. The method of claim 15, further comprising:
accepting information of a third party;
validating the information of the third party;
establishing an identity of the third party; and
associating the identity of the user with a mobile communication number of the third party.

18. A machine readable medium having instructions stored thereon that when executed cause a system to:
accept information of a user applying and/or possessing a mobile communication service;
validate the information of the user;
establish an identity of the user; and
associate the identity of the user with the mobile communication number.

19. A system to support user identity authentication, comprising:
means for accepting information of a user applying and/or possessing a mobile communication service;
means for validating the information of the user;
means for establishing an identity of the user; and
means for associating the identity of the user with the mobile communication number.
